(19) United States
(12) Patent Application Publication
(10) Pub. No.: US 2025/0190473 A1
(43) Pub. Date: Jun. 12, 2025

(54) SYSTEM AND METHOD FOR STREAMLINING CONTENT PRODUCTION USING ARTIFICIAL INTELLIGENCE

(71) Applicants: Orlando Wood, Beverly Hills, CA (US); Vijay Dewan, Beverly Hills, CA (US); Caleigh Peters, Beverly Hills, CA (US)

(72) Inventors: Orlando Wood, Beverly Hills, CA (US); Vijay Dewan, Beverly Hills, CA (US); Caleigh Peters, Beverly Hills, CA (US)

(21) Appl. No.: 18/972,700

(22) Filed: Dec. 6, 2024

Related U.S. Application Data
(60) Provisional application No. 63/608,158, filed on Dec. 8, 2023.

(51) Int. Cl. G06F 16/34; G06F 16/3329; G06F 40/30

(52) U.S. Cl. CPC G06F 16/345; G06F 40/30; G06F 16/3329

(57) ABSTRACT

A system and method for appraising film screenplays and offering predictive insights on their marketability and potential success. The artificial intelligence model and machine learning algorithms consider various production elements and generate management and production outcomes on an expedited timeline. The web services infrastructure implemented creates an enhanced ecosystem for creative development, production, and talent management by minimizing obstacles such as the inaccessibility of information and data about both national and global development trends. Moreover, the system can summarize creative data and create loglines, character breakdowns, titles, and summaries. An A.I generated a sociological analysis that provides a multi-faceted and comprehensive outlook on industry-related research, such as a cost-benefit production analysis.

### CROSS REFERENCE TO RELATED APPLICATIONS

This application claims the benefit of U.S. Provisional Patent Application Ser. No. 63/608,158, filed Dec. 8, 2023, the contents of which are incorporated herein by reference.

### BACKGROUND OF THE INVENTION

There is a dilemma in the film and entertainment industry regarding creative development. Approximately 20% of scripts written are read by executives, whereas only a meager three percent of scripts are made each year. Creative data such as scripts and books, among other forms of content, experience hindrances in development due to archaic systems and processes within the film industry. Present systems cannot manage the sheer volume of creative data, and human fatigue can make digesting this creative data difficult.

The present invention provides a creative development tool powered by artificial intelligence to help engage executives, talent managers, and agents and allow them to interact with and analyze creative data more efficiently and in more significant numbers. The system utilizes artificial intelligence to provide a comprehensive summary, character breakdown, and incisive analysis of scripts and other written content to help create a holistic narrative of a body of work. The interactive system allows users to directly interact with AI through natural language processing and discuss subjects such as story elements, plot points, and suggestions using historical data and current trends. Notably, the system is encrypted and secures creative data without training from it.

The qualities mentioned above aid in remedying the issue of slow-moving creative development by digesting multiple scripts and creative data and providing searchable, expeditious output. This process saves time, money, and resources and allows personnel to focus on maximizing the development of creative works, thus giving all creatives a chance to hear their stories.

### SUMMARY OF THE INVENTION

The present invention pertains to a system and method for streamlining content production using artificial intelligence. The process entails not only providing resources at various points of film production but pre-production development as well.

In one embodiment, the present invention delivers a comprehensive summary, character breakdown, and analysis of an inputted script, also referenced as creative data, stored in the Koobrik Smart Storage System. The present invention utilizes natural language processing models to extract and structure creative metadata from television scripts, film scripts, books, and other media content. The language models parse through the scripts to identify key information including characters, character attributes like ethnicity and nationality, locations, production notes like stunts and wardrobe, and any copyrighted material requiring clearance. This information is then stored in a centralized database optimized for quick recall and analysis.

The core component called SmartStorage allows users to query the database using natural language and receive structured data outputs. For example, a producer could ask “What South American actors could play characters over age 50 in the script?” and SmartStorage would return the relevant character names, actor attributes, and script locations. Another example could be the input, “Hey Koobrik, there is a new tax rebate in Hawaii that makes filming there cheaper. Please send me scripts that have been submitted over the past 5 years that film in a tropical locale.” The system would then scan and sift through the database and archives of all script content that take place over various tropical locales. As such, the SmartStorage system enables rapid search and discovery of correlations across the metadata. If the search query does not already exist in the system, an alert can be generated so that whenever criteria that is met enters the system, a user can be alerted.

By breaking down scripts into discrete, machine-readable data points, the present invention streamlines development, production, and post-production workflows. The structured metadata assists coordinating tasks across departments like casting, locations, props, wardrobe, and more. It also aids activities like budgeting, scheduling, permitting, and tax incentive planning which require aggregating data from multiple sources.

The present invention offers customized tools to optimize studio operations including project trackers, budgeting software, tax incentive trackers, box office predictors, and collaboration portals. These tools are all powered by our core technical innovation of extracting and organizing creative metadata using natural language processing. This enables frictionless information sharing and work coordination, saving clients substantial time and overhead. They can quickly glance at a dashboard to get an overview of a project rather than digging through reams of unstructured documents.

The present invention provides a comprehensive solution to unlock the value in written media content for streamlining and optimizing the production workflow. Converting creative scripts into structured data provides the foundation for the next generation of entertainment analytics and collaboration software.

The present invention chunks a scene, summarizes it, and then appends it into a more comprehensive summary that is saved and indexed within the aforementioned Koobrik Smart Storage system. The summary is then reduced down to the client's desired output, typically using interactions with the chat bot in order to fine-tune the output. The metadata pertaining to the character, genre, writer, etc. is pulled out of the script, indexed and databased.

For television, every episode of a television show is summarized, similar to film input. When a final summary is generated, it is stored in a database and reviewed by the A.I engine. Every episode then generated a new summary at the end of an episode in addition to a summary of all previous episodes so that the system can have every element of the storyline. When a new season is started and adapted, the system provides a season-long summary to understand how the next episode fits into an ongoing narrative.

The chat bot uses a vector index to imbed each of the component parts of a script so that the chat has access to every degree of analysis in order to produce an output. The system can provide ranked scripts, or highly-appraised works if requested by a user. Moreover, the system can summarize major plot points, relationships between characters, and all questions regarding database content stored in Koobrik's Smart Storage.

Every creative data input is saved in a database and is searchable using the creative metadata. The artificial intelligence engine employs natural language processing and queries so that a user may directly interact with the system, and the system can provide an output that resolves the query and generates feedback. Moreover, creative metadata is saved in an encrypted database, and all content can be erased at the user's discretion. Unless specifically requested, the engine operates without saving and training on a user's data. The memory operates as institutional memory, and all inputted data can be accessed across different locations.

The A.I engine operates by indexing content in the Smart Storage system, and indexing all the embeddings so that a user can query their database and create alerts when the database adds something that is of interest to the user. A user profile module is supported on the platform to allow various actions such as flagging for scripts, stories, characters, or genres. In turn, a user may interact through a chat bot to find the specific return they're looking for, whether it's a character summary, an updated budget, or retrieving a highly-appraised script for a particular genre. The database is able to send a user an alert when it receives a script or project that matches the criteria requested by a user. The database is constantly updated to supply the user with a desired output using the most up-to-date iteration of the works available in the database.

Another feature of the present invention is maximized data analysis. Story data can be cross-tracked to streaming data, and the engine can assess and analyze the exact moments audiences tuned out of a show, storylines that do not pique viewers' interests, among other story-related trends that imply a causal relationship with the audience. Scripts can be cataloged and categorized for easy retrieval and to help provide users and companies with insights on key themes and elements of the creative data itself.

The system's database also cross-references current box office data to suggest scripts that may be of interest according to current trends and dissect the cost-benefit analysis of the development of scripts of interest. In addition, marketing trend analyses are performed, which allow the system to analyze social and sociological trend metrics to guide marketing during development. Other features include opportunity analysis, which pinpoint when scripts may be best developed based on an assortment of factors, such as new tax incentives and the success of a script using available metrics, popularity in the genre, etc. Alerts can also be pre-set to be received when a script matches sought criteria or box office trends.

The system also allows various file types, such as MP4, MP3, .png, jpeg, and .gif files, to be input into the system and yield results. As a result, the system can be used by more than just the film production industry. Musicians can input their audio files and song drafts and ask for creative input from the artificial intelligence engine. Similarly, the song may be cross-referenced to a musical database and warn of any potential copyright issues using a similarity match. Visual media input, such as film trailers, teasers, etc. can also return loglines, perceived ambience, genre suggestions, short summaries, and provide a user with data on how the teaser may be perceived by audiences on small and global scales.

The present invention also operates as a management platform for talent agencies and management companies. Client tracking and searching can allow agents or managers to get feedback on characters corresponding to their client profiles. Personnel may update profiles and inform the system of opportunities and specs their clients are looking for, such as shoot locations, and shoot dates, and set alerts for criteria that correspond with an agency's demand.

Developmental support is also another facet of the invention. Scripts can be compared to previous drafts, and artificial intelligence's natural language processing allows personnel to interact with the database and ask specific script and story queries.

The engine allows for production tracking and management and provides data pertinent to global market trends, such as foreign sales. By way of example, this data can be personalized, and specify market trends per genre and supply production companies with actor data per market for casting, box office comparisons and projections, and budget proposals with prop lists, location lists, scheduling, and movie magic budgeting integration. Other assistive casting features include character breakdowns, line counters, and talent list generators. Regarding the budget, the present system can also provide alternative pathways to mitigate production costs such as more economic talent, props, and elements from the industry's marketplace. Script input can provide chronological times story and character elements, and diegetic data on said story character elements. The system may offer schedule makers for production and data available for movie magic or tracking software. In turn, a user can see visual data that helps them determine whether cost-cutting is effective using the cost-benefit analysis.

In the present invention's system, a user has control over the types of returns they would like to generate. A user can request an appraisal on their creative data and interact with a chat bot powered by artificial intelligence to answer questions they have about the input. They can request word suggestions, tone suggestions, and in other embodiments, request mood boards and resources to help develop their vision. All results yielded by the system are dated and recorded, and can be tagged and compiled in folders for easy access.

Other features and aspects of the invention will become apparent from the following detailed description, taken in conjunction with the accompanying drawings, which illustrate, by way of example, the features by embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is an overview of one embodiment of the present invention.

FIG. 2 is an overview of the application's AWS organization.

FIG. 3 summarizes the system's creative data and artificial intelligence interactions. Creative data is stored securely, and content owners have autonomy over the saved data.

FIG. 4 showcases the automated pipeline that ingests screenplay data.

FIG. 5 showcases the platform's architecture.

FIG. 6 depicts the hardware and software architecture of the present invention.

FIGS. 7 and 8 display the exemplary operating environment in which embodiments of the present invention may be implemented.

FIG. 9 is a diagram of the artificial intelligence and machine learning algorithm's relationship with various elements of production management.

FIG. 10 depicts the present invention's web services structure and the relationship between all applications the web service uses to operate.

FIG. 11 is a diagram showing the communication between the storage end users, the network platform, and the various elements that help effectuate operations.

FIG. 12 is a diagram showing the web services of the platform and system.

FIG. 13 illustrates server-to-server connections within a server room and to other server room locations.

FIG. 14 depicts the web services model of the present invention. The web services model extracts data, stores it within local or cloud memory, and allows a user to manage the data.

FIG. 15 is a diagram of the flow of access between the platform of the present invention and the web services client via cloud software tools.

FIG. 16 is a depiction of the AWS extraction process.

FIG. 17A is a diagram of the movie title process and variables.

FIG. 17B is a diagram of the movie characters' breakdown and variables.

FIG. 18A is a diagram of the movie comments process and variables.

FIG. 18B is a diagram of the movie logline process and variables.

FIG. 19 is a diagram of the process for retrieving a reduced movie synopsis.

FIG. 20 is a diagram of the movie script routine.

FIG. 21 is a diagram displaying the movie summary prompt and variables.

FIG. 22 is a diagram of the visual and text input which yields a return after processing the input data.

FIG. 23 is a line diagram illustrating a decentralized network.

FIG. 24 is a line diagram illustrating a distributed network.

FIG. 25 depicts the relationship between the input using the storage system and large language model and the output generated in a user profile.

FIG. 26A depicts the SmartStorage System input model.

FIG. 26B depicts the SmartStorage System output model.

### DETAILED DESCRIPTION OF THE PREFERRED EMBODIMENT

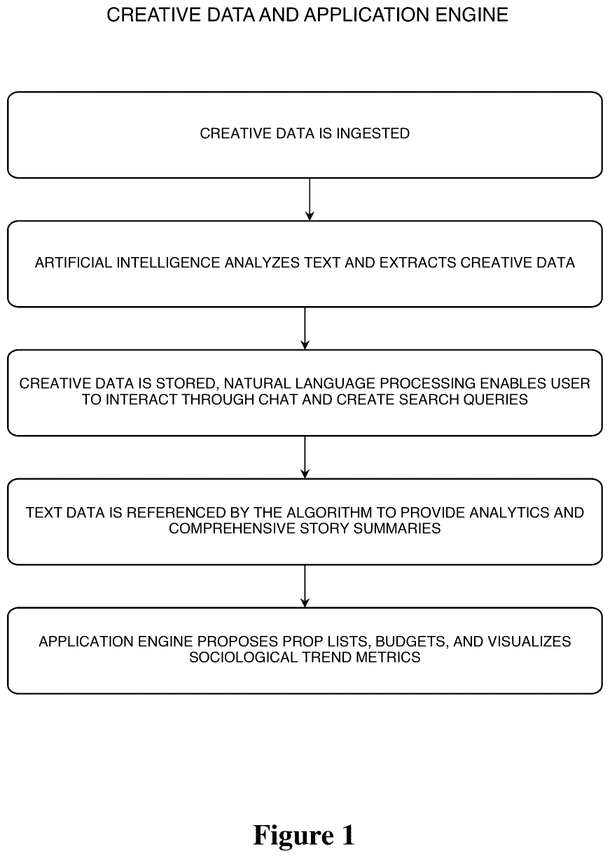

FIG. 1 is an overview of one embodiment of the present invention. Creative data is ingested, artificial intelligence analyzes text and extracts creative data. This creative data is stored, and natural language processing enables the user to interact through an LLM (large language model) chat to create search queries. The algorithm then references the text data from the input to provide analytics and comprehensive story summaries. The application engine proposes prop lists, and budgets, and visualizes sociological trend metrics and relevant marketing data that may benefit management companies.

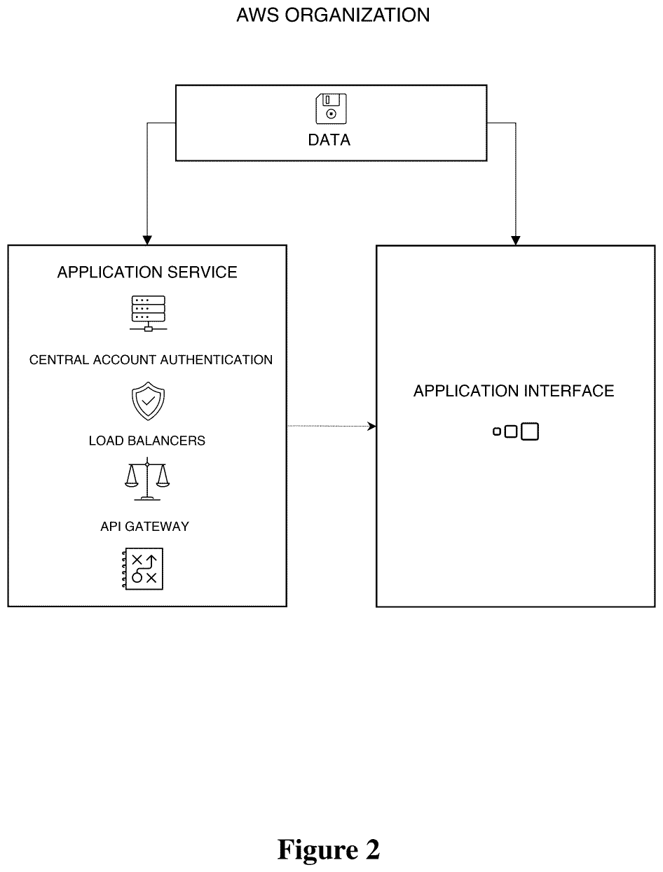

FIG. 2 is an overview of the application's AWS organization. Data includes either creative data or data that pertains to the requisites of specific management and production companies, by way of example and not limitation, specifications for a casting call, or a list of genres they are seeking to produce. This data is hosted on the application service through the application interface. The application service, supported by Amazon Web Services (AWS), features backend central account authentication, load balancers, and API gateways to present the application interface and to serve clients with the program's module.

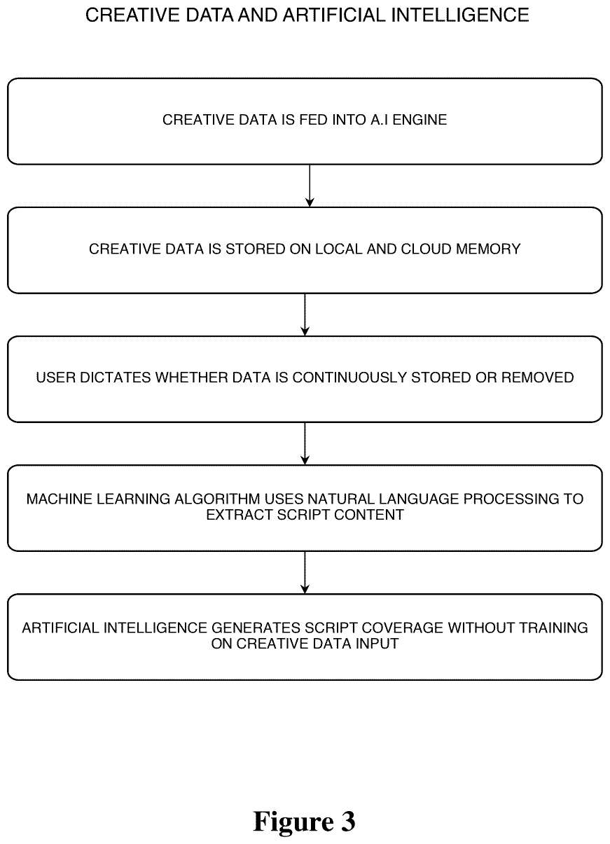

FIG. 3 summarizes the system's creative data and artificial intelligence interactions. Creative data is stored (in cloud memory), hosted through the web services platform, and fed into the artificial intelligence engine to provide comprehensive summaries of the content. The user may dictate whether or not the content stays on the platform or if they would like to remove it at will. This ensures that a user's privacy is not infringed upon and provides a sense of security for the user regarding what the machine learning algorithm digests. The system uses a machine learning algorithm to extract information and text to procure desired results, whether it is a script summary, a prop list, a casting list, or a location list. A budget is also provided for all the requested materials. The algorithm does not train on the materials sent or data uploaded to the server.

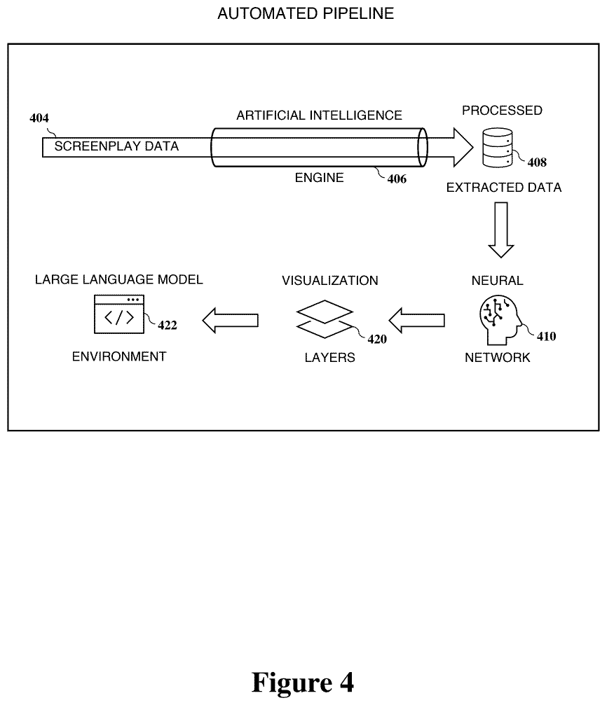

FIG. 4 showcases the automated pipeline that ingests screenplay data. While the figure explicitly states screenplay data 404, all creative data capable of extracted and processed through the artificial intelligence engine 406. The processed, extracted data 408 is used to generate analytics through a neural network that may derive from multiple search streams, application programming interfaces, and the AWS marketplace. The application controls an LLM environment using application, data, training, and visualization layers 420. Data that is fed can be template or boilerplate data, or scripts itself. Data 404 that is input from local memory and stored in cloud databases may be altered and removed at a user's discretion. The artificial intelligence engine 406 and large language model 422 does not train on the datasets input by users, so no data input into the model is adopted and expropriated by it.

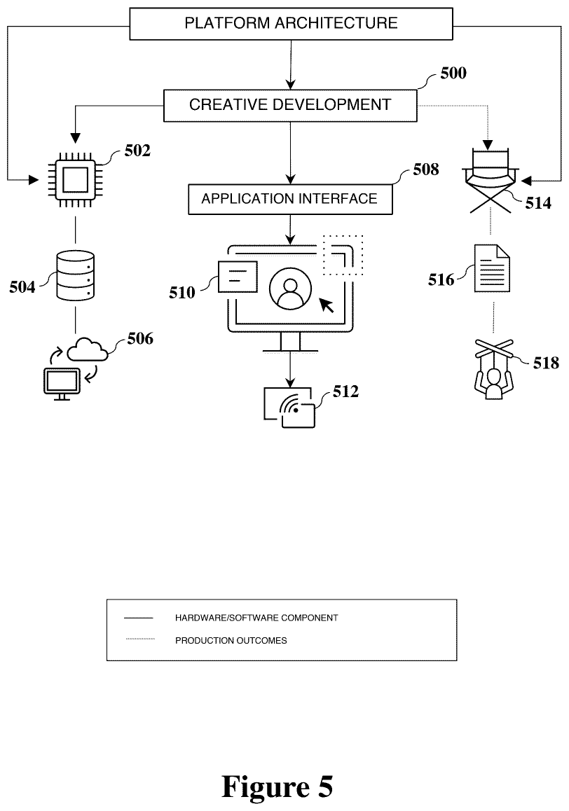

FIG. 5 showcases the platform's architecture. On the left side are hardware and software components, such as processors 502, a database 504, and a cloud server 506. Creative development is input using a processing device, or output device 512 and stored in a processor 502. The application interface 508 also hosts a database 504 to maintain records of creative data on the cloud. The cloud server 506 stores this data at the user's will. The application interface 508 features modules 510 that display various actions related to creative development using scripts and creative media that can be transcribed 516, including generating prop lists 518 using the data stored on cloud 506. Moreover, the invention allows a user to access the platform and its features as mentioned through the application interface 508 and its modules 510 which are presented on a processing device 512. On the right side, creative development 500 includes music, film and theater production, content creation 514 and any other form of creative media that can be transcribed 516 and stored within the database stored on cloud 506.

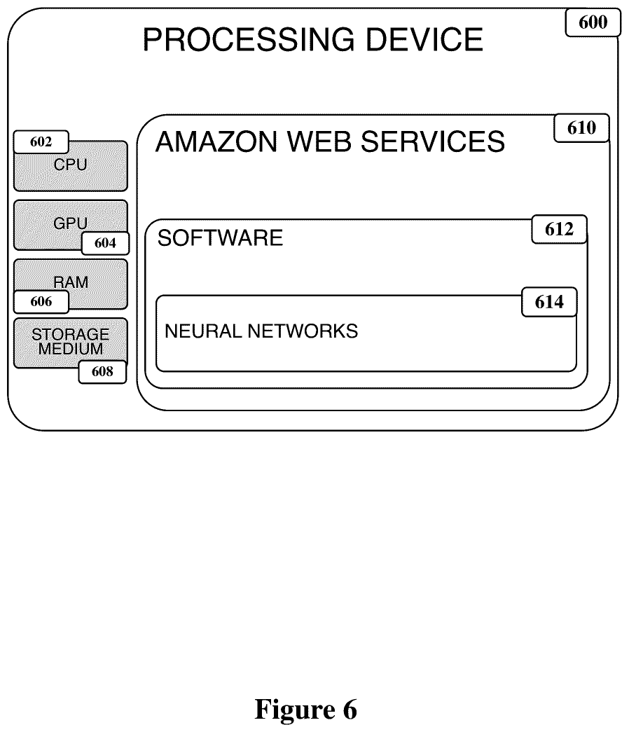

FIG. 6 depicts the hardware and software architecture of the present invention. The present invention requires a processing device 600 with a central processing unit 602, coupled to a memory 606 and storage device 608 that can be cross-referenced to a cloud database and computer-readable programming software to execute code. The present invention also hosts a database stored in local and cloud memory and requires a graphics processing unit to visualize various datasets. The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions, such as an application program or an operating system. The computer program may for instance include one or more of a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer-readable medium. All or some of the computer programs may be provided on computer-readable media permanently, removably, or remotely coupled to an information processing system. The computer-readable media may include, for example, and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software 612 that manages the sharing of the resources of a computer and provides programmers with an interface used to access those resources. An operating system processes system data and user input and responds by allocating and managing tasks and internal system resources as a service to users and system programs.

The computer system operating on the processing device 600 may, for instance, include at least one processing unit 602, associated memory 606, and various input/output (I/O) devices. When executing the computer program, the computer system processes information according to the computer program and produces resultant output information via I/O devices. The present technology requires a data processing system with sufficient memory and processing power to store and recall user data in real-time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage medium 608 to allocate disk drives to disk drive groups.

The neural network operates and serves artificial intelligence and machine learning systems. The neural network exists to help effectuate operations, such as training the algorithm using independent data (specifically data that is not directly from a user's screenplay). The engine operates on neural networks 614 over a web service platform 600 with encrypted databases.

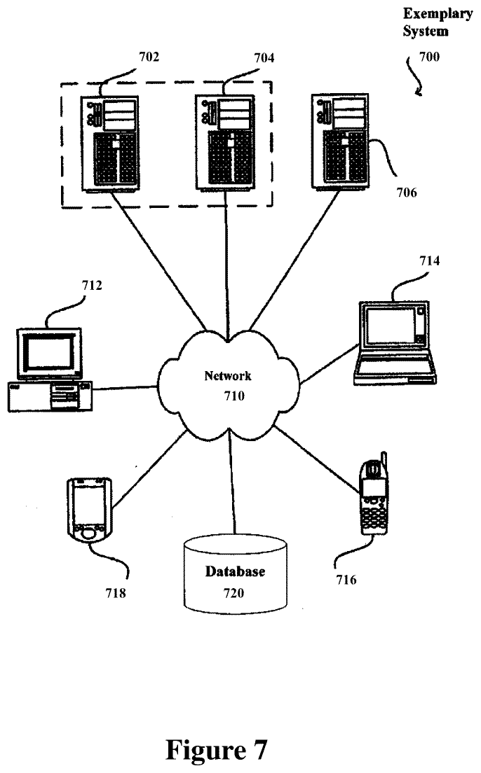

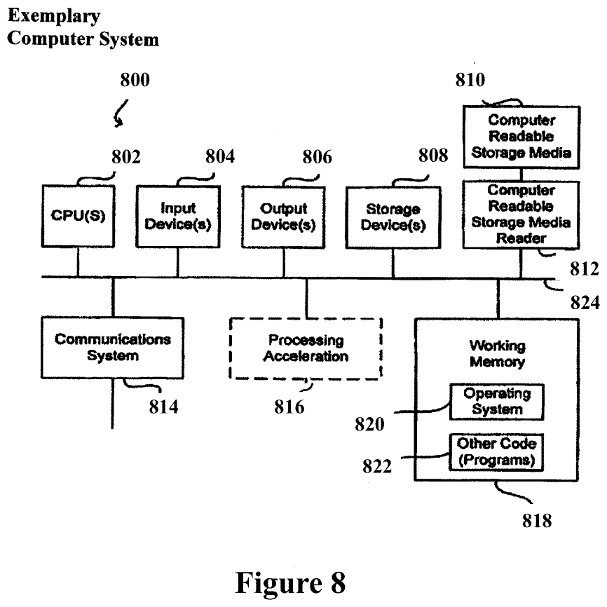

FIGS. 7 and 8 display the exemplary operating environment where embodiments of the present invention may be implemented. The system can include one or more user computers, computing devices, or processing devices that can be used to operate a client, such as a dedicated application, web browser, etc. The user computers can be general-purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers may also have various applications, including one or more development systems, database client and/or server applications, and Web browser applications. Alternatively, the user computers may be any other electronic device, such as a thin-client computer, Internet-enabled gaming system, and/or personal messaging device, capable of communicating via a network (e.g., the network described below) and/or displaying and navigating Web pages or other types of electronic documents. Although the exemplary system is shown with four user computers, any number of user computers may be supported.

The web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers that can be capable of executing programs or scripts in response to the user computers. As one example, a server may execute one or more

Web applications. The Web application may be implemented as one or more scripts or programs written in any programming language, such as Java.RTM., C, C #, or C++, and/or any scripting language, such as Perl, Python, or TCL, as well as combinations of any programming/scripting languages.

The server(s) may also include database servers, including without limitation those commercially available from Oracle.RTM., Microsoft.RTM., Sybase.RTM., IBM.RTM. and the like can process requests from database clients running on a user computer. The generation of notes occurs by programming a code to operate the front and back end. The designated web service helps execute operations pertaining to data entry storage so that a user can cross-reference their notes on various browsers without the need for manually adding an extension. The web service platform helps effectuate operations by running scripts and encrypting data so that it can be safely referenced on various devices without the need to synchronize them. The program allows a user to take notes and configure them to the web service. Moreover, operating on a web service and network platform helps create customizable tags that can be accessed not only through a primary platform but secondary ones as well.

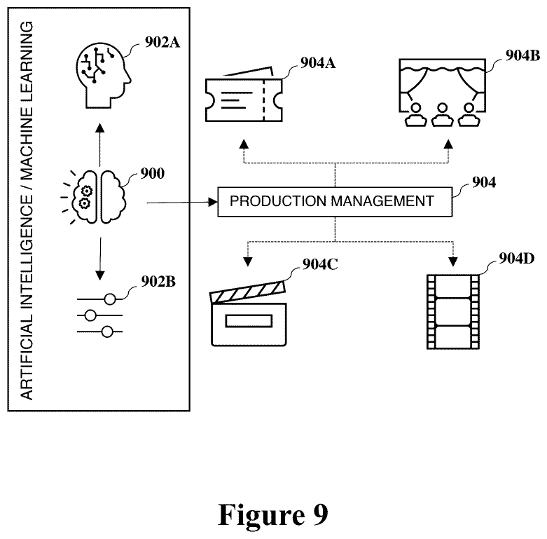

FIG. 9 is a diagram of the artificial intelligence and machine learning algorithm's relationship with various elements of production management. The artificial intelligence and machine learning infrastructure comprises of machine learning and artificial intelligence systems 902A, which operate on neural networks 900 and produce algorithms 902B using data input. Production management features include predicting box office success 904A using the contents of a script, production costs and budgeting 904C, talent acquisition 904B, and film and script appraisal 904D. The data input can be any form of creative media, from music, books, and skit scripts. All media is compatible with the present invention's neural networks and machine learning algorithm. MP3 and MP4 data can also produce appraisals when transcribed, and the transcribed text is the data input.

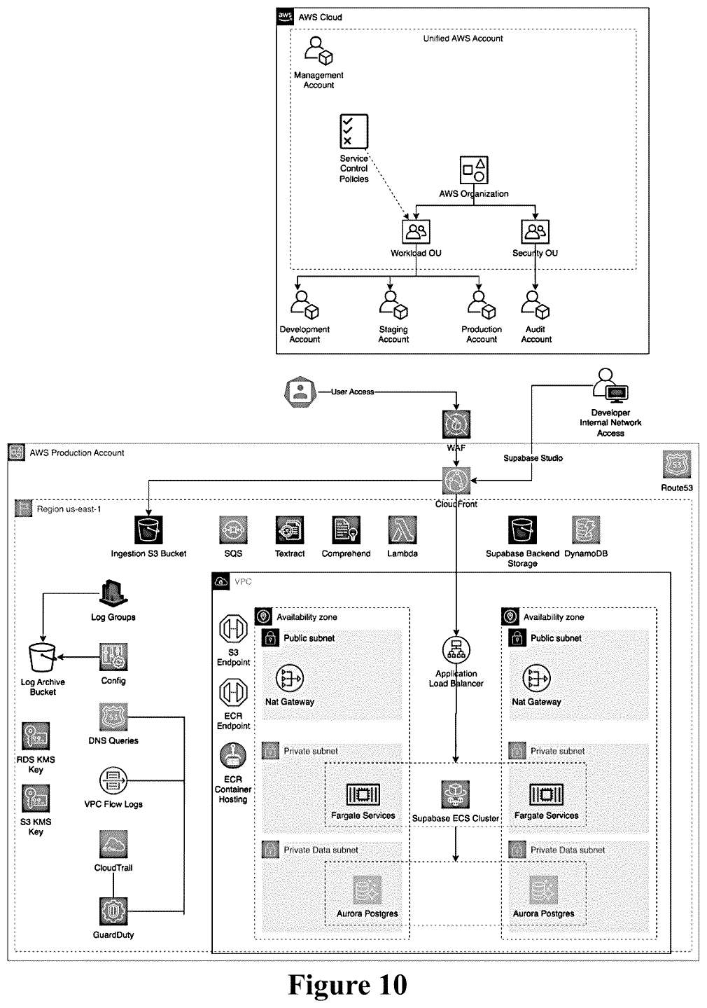

FIG. 10 is a depiction of the present invention's web services structure and the relationship between all applications the web service uses to operate. The cloud account has a management account that enables, through the back end, control and management of the cloud's organization. The production account uses multiple applications to support CloudFront and effectuate operations such as data ingestion for the machine learning algorithm's output.

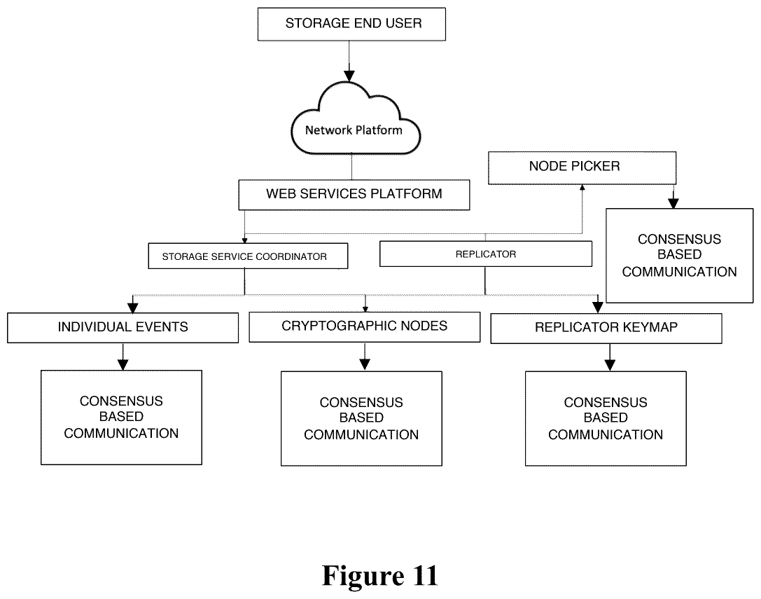

FIG. 11 is a diagram showing the communication between the storage end users, the network platform, and the various elements that help effectuate operations. The storage end user communicates and relays various pertinent data bits to the network platform. The network platform operates on the web service platform, which features a storage service coordinator and replicator. Each service utilizes a node picker, which helps establish consensus-based communication. The storage service coordinator maintains and records individual events and cryptographic nodes or keys that are used for operations. The replicator's keymap generates consensus-based communication, along with the cryptographic nodes and individual events.

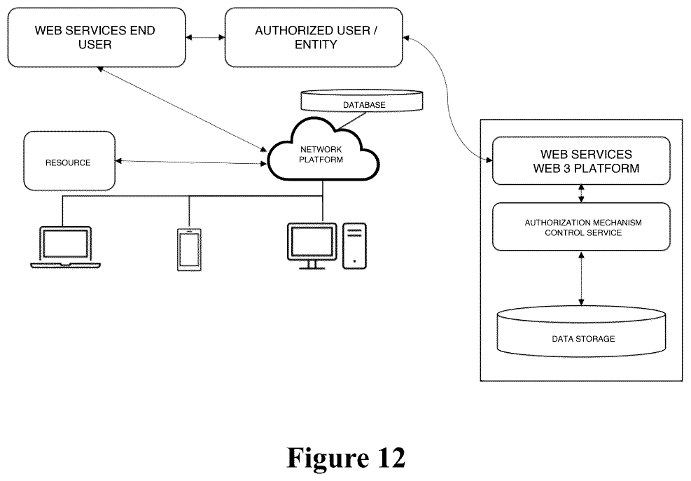

FIG. 12 is a diagram showing the web services of the platform and system. The platform and system are all components of an exemplary operating environment in which embodiments of the present invention may be implemented. The system can include one or more user computers, computing devices, or processing devices that can be used to operate a client, such as a dedicated application, web browser, etc. The user computers can be general-purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers may also have any of a variety of applications, including one or more development systems, database client and/or server applications, and Web browser applications. Alternatively, the user computers may be any other electronic device, such as a thin-client computer, Internet-enabled gaming system, and/or personal messaging device, capable of communicating via a network (e.g., the network described below) and/or displaying and navigating Web pages or other types of electronic documents. Although the exemplary system is shown with four user computers, any number of user computers may be supported.

In most embodiments, the system includes some network. The network can be any type familiar to those skilled in the art that can support data communications using any of a variety of commercially available protocols, including, without limitation, TCP/IP, SNA, IPX, AppleTalk, and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; an extranet; public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, WiMAX, WiFi, CDMA 2000, WCDMA, the Bluetooth protocol known in the art, and/or any other wireless protocol); and/or any combination of these and/or other networks.

End users, or users that are viewing and using the network platform, all contribute data to the cloud. A web service platform helps secure that data and maintain the service's functionalities. Only authorized users and entities can authorize or unauthorize content and monitor data stored within the web service. The platform's web services help maintain the operations of elements managed by the storage system.

The system may also include one or more databases. The database(s) may reside in a variety of locations. By way of example, a database may reside on a storage medium local to (and/or resident in) one or more of the computers. Alternatively, it may be remote from any or all of the computers, and/or in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10g, that is adapted to store, update, and retrieve data in response to SQL-formatted commands.

Per the preferred embodiment, a web client interacts with the server ecosystem through a service connection, such as the internet, which then distributes data and pertinent information such as the web service platform to the cloud server and preliminary servers. This allows for data to be streamlined between the client and the server, as well as cloud servers and other database systems. Communication between web services may be completed via Simple Object Access Protocol (SOAP), which allows multiple web service applications to communicate rapidly and efficiently and to provide data to the web client.

The infrastructure of the present invention also allows for the use of web services that enable interaction with and storage of data across devices. Specifically, these web services allow for the use of cloud software tools and cloud-based data storage. Cloud software tools can be used to allow for increased user authentication and authorization checkpoints for data accessed between parties. The web service software aids in the transmission of data between entities while maintaining secure access restrictions, preventing any unauthorized access to the cloud data.

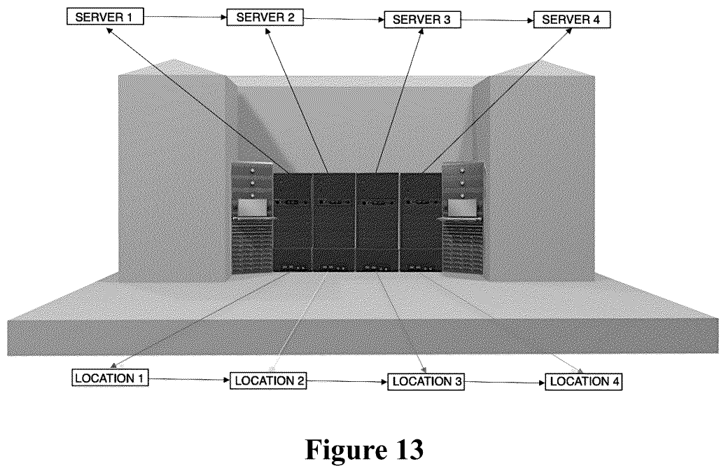

FIG. 13 illustrates server-to-server connections within a server room and to other server room locations. The web server undergoes an initialization process and features a database of wireless network data. Depending on the service requested, the data may undergo processing. The servers actively attempt to retrieve the appropriate data to provide user input. Data may then be formatted and saved or restructured with the appropriate authorizations.

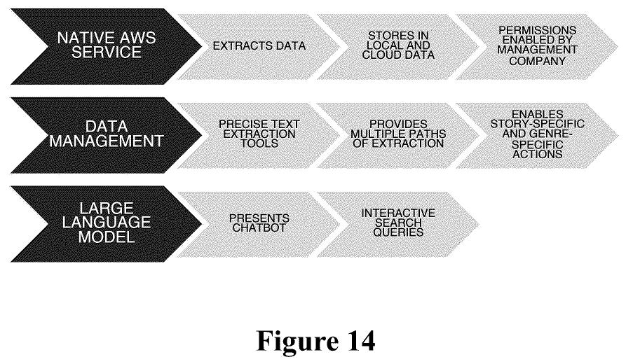

FIG. 14 depicts the web services model of the present invention. The web services model extracts data, stores it within local or cloud memory, and allows a user to manage the data. For example, an authorized user may choose to erase all data they have input or to maintain data to dictate what the system does with the creative data it ingests. Creative data is managed and reviewed using precise text extraction tools, which include transcriptions for MP4 and MP3 formats. For example, an MP3 song may be input into the engine and transcribed and use the appraisal tools during the lyrical process. Or, a trailer may be input and ideas generated to help create a story using the visual transcriptions and text. The data management system can also include one or more databases that all operate on the smart-storage system. The large language model summarizes the input, appends all input responses together to create a final summary of the creative data, and then reviews the summary and amends it according to a user's query.

The database may reside in a variety of locations. By way of example, a database may reside on a storage medium local to (and/or resident in) one or more of the computers.

Alternatively, it may be remote from any or all of the computers and/or in communication (e.g., via the network) with one or more of these. In particular embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10g. that is adapted to store, update, and retrieve data in response to SQL-formatted commands. The database supports a third-party chatbot, a large learning model, through the AWS platform for interactive search queries regarding a script and to provide real-time feedback based on the text in the datasets. Interactive search queries allow a user to interact with the text, and ask for suggestions, corrections, appraisals, prop lists, etc. using the A.I chatbot.

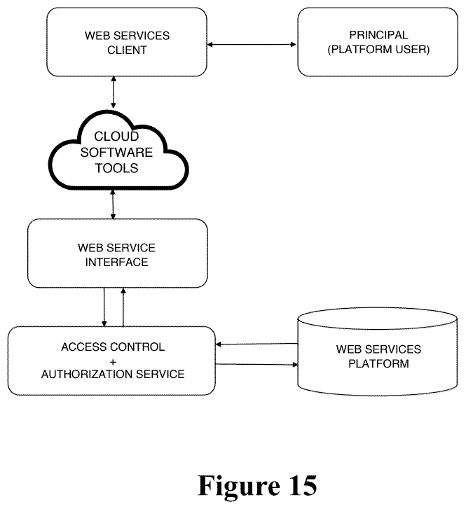

FIG. 15 is a diagram of the flow of access between the platform of the present invention and the web services client via cloud software tools. The principal or platform user accesses the web services client, which then transmits data via cloud software tools to the web services interface. Access control and authorization act as a layer to access the web services platform by way of the web services interface.

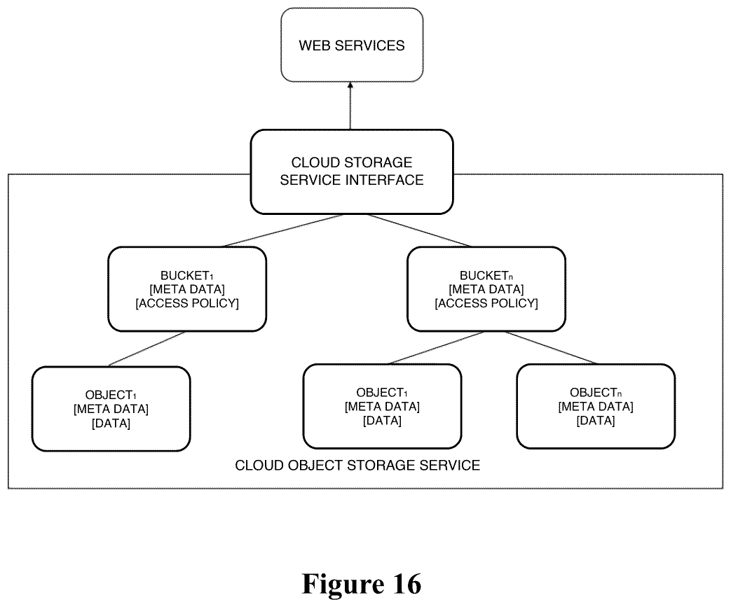

FIG. 16 is a depiction of the AWS extraction process. AWS establishes secure connections using the system's programming infrastructure and extracts textual data stored in ingestion buckets. Then, the program configures text to process various script formats stored therein and then uses structured forms and tables to extract textual data. Step functions create an automated workflow. Metadata is then structured and stored and may be visualized on an application programming interface. This metadata can be presented according to the algorithm in which the artificial intelligence models are trained in. For example, a visual display of a production budget can be generated using text data that imply a location and/or the usage of particular props that accounting personnel can use, and a cost-benefit analysis of an entire production, alongside the potential success in the box market. The depiction is also of the cloud storage organization in which the web services access and retrieve user data as objects in buckets within a cloud storage space. The cloud storage service is a means of storing and protecting any amount of data for various use cases. A bucket is a container for objects stored in the cloud storage service, and objects consist of object data and metadata. The metadata is a set of name-value pairs that describe the object. These pairs include some default metadata, such as the date last modified, and standard HTTP metadata, such as Content-Type. One can also specify custom metadata when the object is stored. Web services provide access to and from the cloud object storage service via the cloud storage service interface.

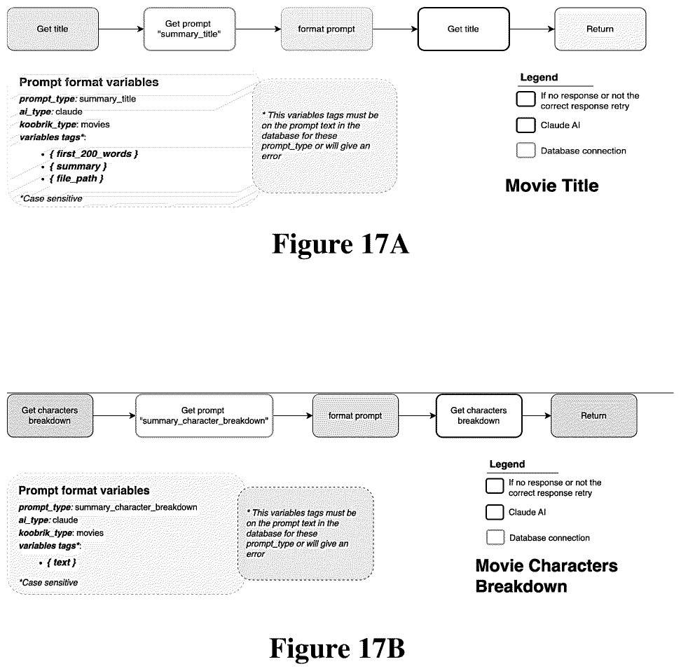

FIG. 17A is a diagram of the movie title process and variables. The process entails getting the title of the movie and retrieving the prompt using a summary. The prompt is then formatted to produce a title and provide it. This is executed using a database connection and an A.I algorithm.

FIG. 17B shows the movie characters' breakdown and variables. The process comprises retrieving a character breakdown and then requesting a prompt for a character breakdown using the creative data that is input into the engine. The prompt is then formatted, and the generated breakdown is returned to the user.

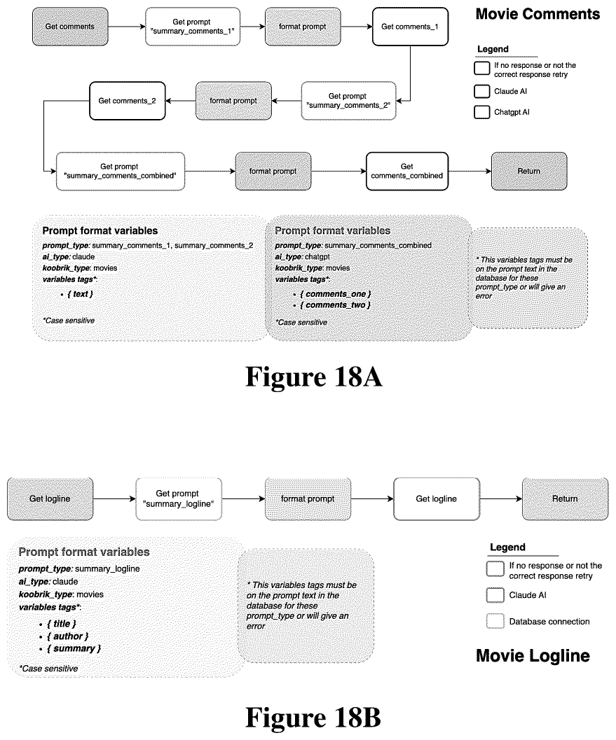

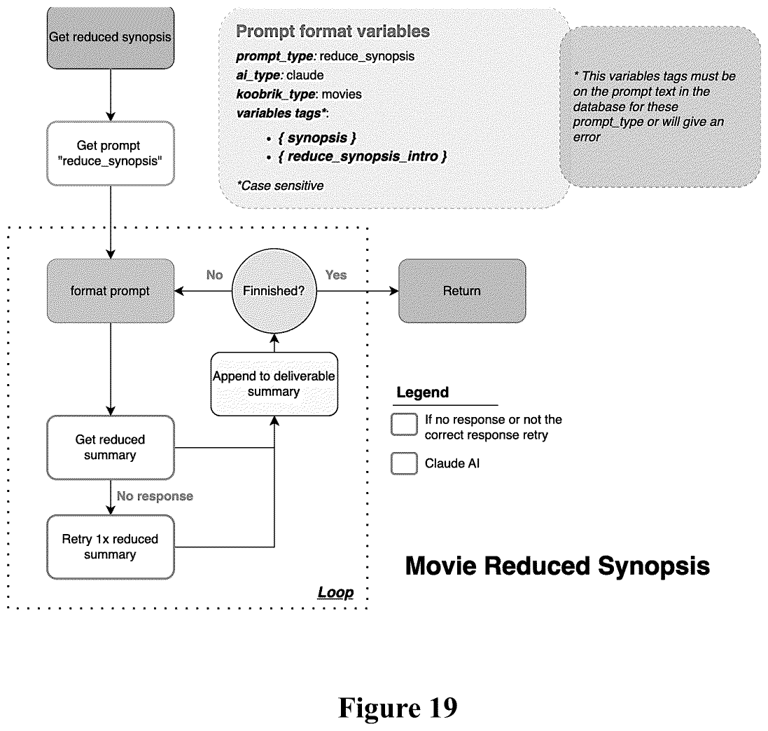

FIG. 18A is a diagram of the movie comments process and variables. The prompt requests comments using the prompt variable. The prompt is formatted to retrieve comments from the application's database, and the process is repeated to provide a combined set of comments for the end user. The process utilizes artificial intelligence and large language models (such as Claud AI and ChatGPT AI) by way of the database to provide multiple comments for the desired piece of media.

FIG. 18B is a diagram of the movie logline process and variables. The system gets the logline by way of the summary logline prompt. The prompt is then formatted to retrieve the logline and return it to the end user. The process utilizes artificial intelligence and the database to provide a logline using the contents of the inputted creative data.

FIG. 19 shows the process for retrieving a reduced movie synopsis. The prompt entails retrieving a reduced synopsis of the creative data that is input into the system. The formatted prompt is then returned to the end user. If the end user is unsatisfied with the reduced synopsis, they may request an amended reduced summary. The artificial intelligence engine will retry different variables if the deliverable is not up to the user's standard.

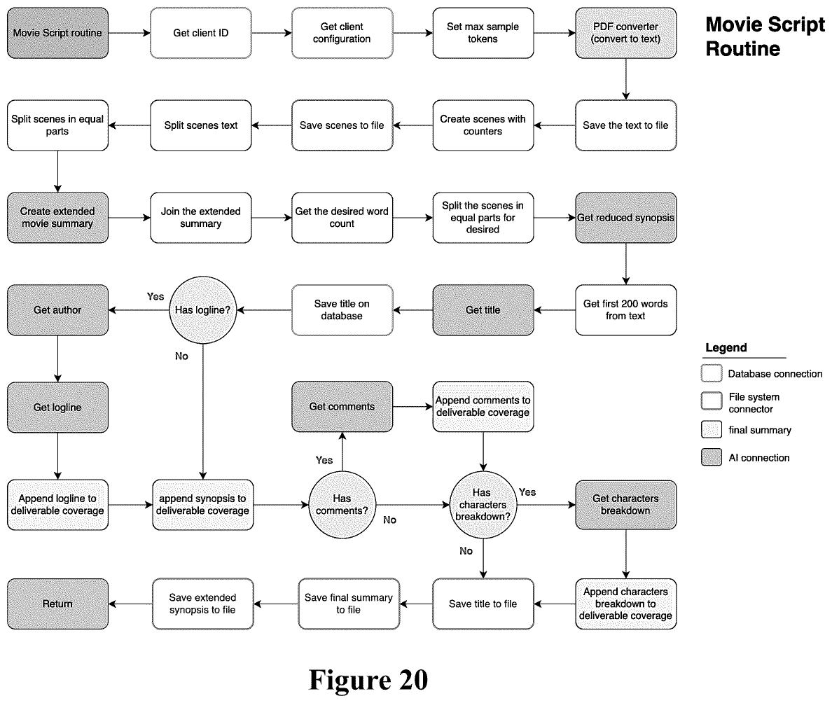

FIG. 20 is a diagram of the movie script routine. The client ID and client configuration is retrieved. The system sets the max sample tokens, and then the PDF converter converts the inputted creative data into text. Scenes are delivered and saved once the data is saved as a text file. The file system connecter then splits the scene into equal parts, and an extended movie summary is A.I generated. The database connection splits the scene into equal parts, and the Al connection reduces the synopsis. The file system then connects back to the A.I connection to get a title for the movie script and save the title on the database. The final summary prompt generates a query to determine if the parameters are met. If the movie has a logline, then the A.I connection retrieves the author's details and then gets a logline. The logline is amended according to the user or company's requests and delivered if ideally formatted. If the movie script does not have a logline, the synopsis is appended to deliverable coverage. Suppose at any point the movie script prompt is commented on by the end user. In that case, the system uses artificial intelligence and the final summary contents to append the routine until it is in appropriate condition. The movie script routine also provides character breakdowns, which may be appended according to the final summaries and comments of an end user and then returned once desirably formatted and presented.

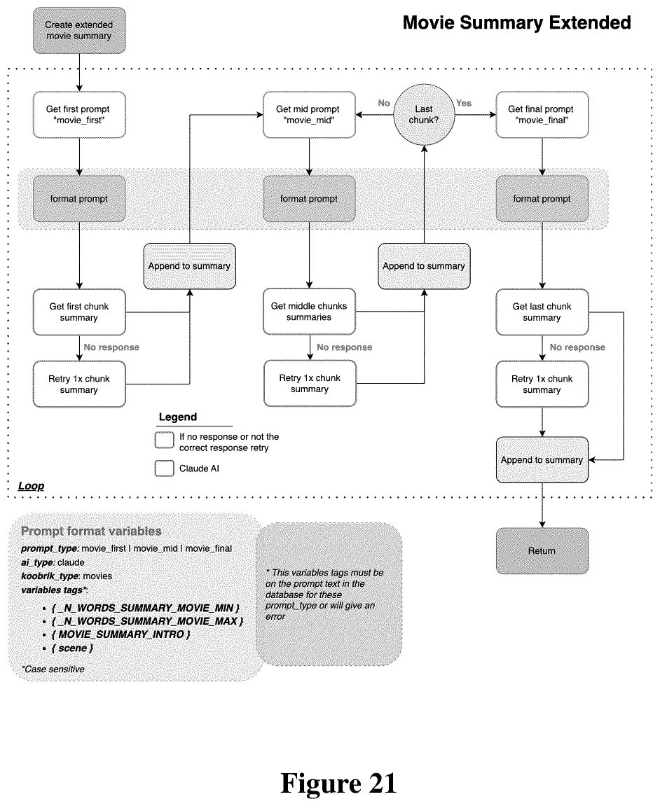

FIG. 21 is a diagram displaying the movie summary prompt and variables. The A.I connection creates an extended movie summary. The database connection retrieves the first prompt and then the A.I connection formats the prompt every time the database connection requests one. When the first prompt is formatted, the first chunk of the summary is retrieved from the file system connector and uses the responses from an end user to retry or submit the first summary. Various stages of the movie are generated by way of the prompts, such as the first, middle, and final parts of a movie using the formatted summary chunks. They are then appended to the summary and returned to the end user.

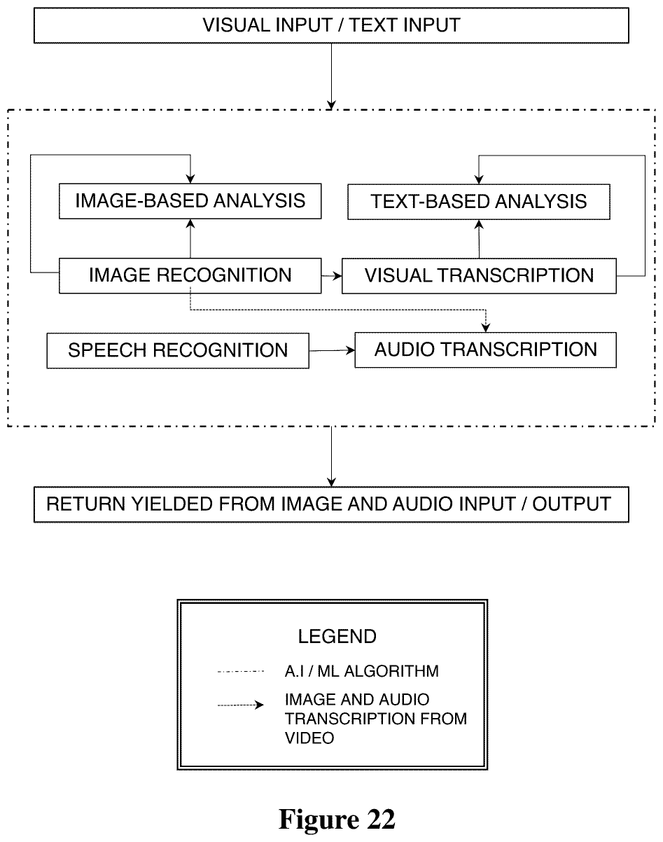

FIG. 22 is a diagram of the visual and text input which yields a return after processing the input data. The visual input and text input can be various formats of creative data, such as a video or audio file, or text based and PDF document. The audio and video files typically come in MP3 and MP4 formats. Visual files and inputs typically come in.png, jpeg or.gif formats. Text based inputs, such as scripts, transcripts, typically present as .doc, pdf and/or .txt files. Text based outputs include descriptions of the content to help aid with story writing, character descriptions, among other things. Text based inputs are transcribed, and visual inputs are described using the artificial intelligence engine. The visual and text input is then sent through the A.I and machine learning algorithm to be processed. Visual inputs with audio are transcribed. An image-based analysis of visual inputs is produced using image recognition software. The analysis can produce more images for mood boards, or descriptions of the concepts and aesthetics of a visual input.

For example, a user may input a series of images that correspond with the aesthetics of a scene, character, location, or other elements. The output cross-references the image and produces a series of similar images. If a user desires, they request the system to procure a list of potential shooting locations reminiscent of the set of visual inputs they have entered. Additionally, the system can produce a list of potential cast list of individuals that are similar to the visual inputs. Or, the audio file can be cross-referenced to potential similar sounding songs and warn of potential infringement.

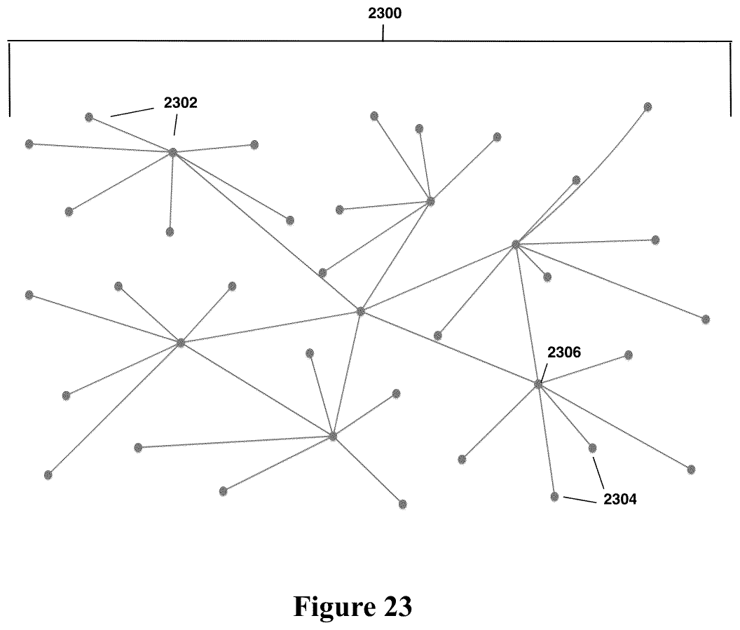

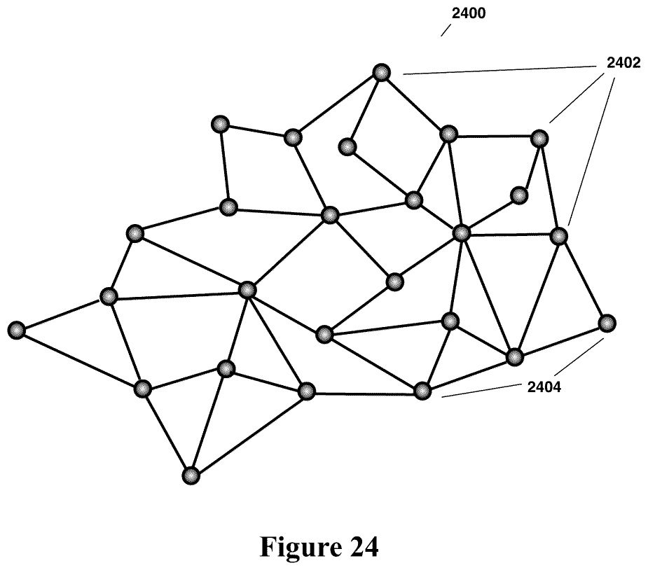

FIG. 23 is a line diagram illustrating a decentralized network. In accordance with the preferred embodiment of the present invention, the specific architecture of the network can be either decentralized or distributed. FIG. 23, generally represented by the numeral 2300, provides an illustrative diagram of the decentralized network. FIG. 23 depicts each node with a dot 2302 Under this system, each node is connected to at least one other node 2304. Only some nodes are connected to more than one node 2306.

FIG. 24 is a line diagram illustrating a distributed network. For comparison purposes, FIG. 24, which is generally represented by the numeral 2400, illustrates a distributed network. Specifically, the illustration shows the interconnection of each node 2402 in a distributed decentralized network 2400. In accordance with the preferred embodiment of the present invention, each node 2402 in the distributed network 2400 is directly connected to at least two other nodes 2404. This allows each node 2402 to transact with at least one other node 2402 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provides services comprising receiving client update information from client devices and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

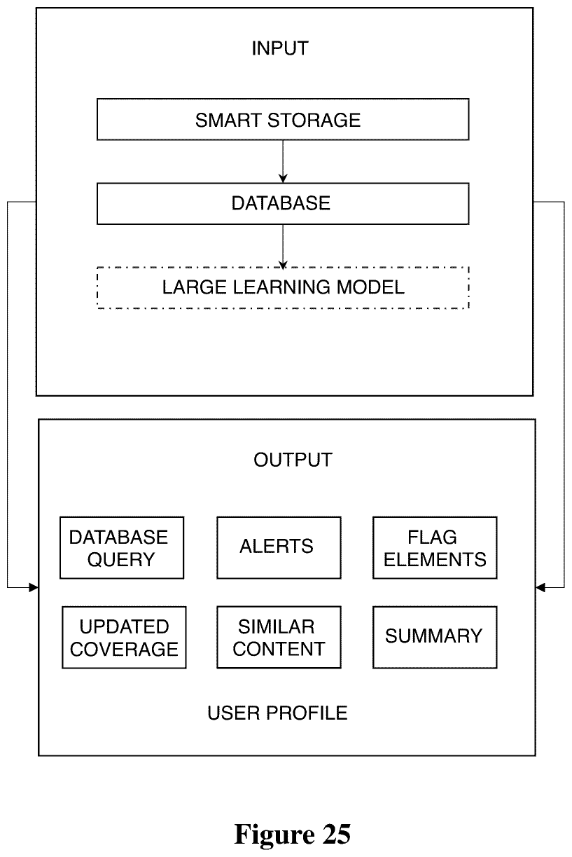

FIG. 25 depicts the relationship between the input using the storage system and large language model and the output generated in a user profile. The LLM (represented by the dashed line to emphasize its function as an A.I engine) is turned on all the vector indexes of the database, which is employed on the Koobrik Smart Storage system, and indexes all the embeddings so that a user can query their database and create alerts when the database adds something that is of interest to the user. In the user profile module, a user can flag for scripts, stories, characters, or genres they are looking for. The database will send a user an alert when it receives a script or project that matches the criteria requested by a user. The database, in real time, communicates with a user as it changes and when input is appended, updated, or entered and lets a user know when it's now in possession of something in your organization that is relevant to them.

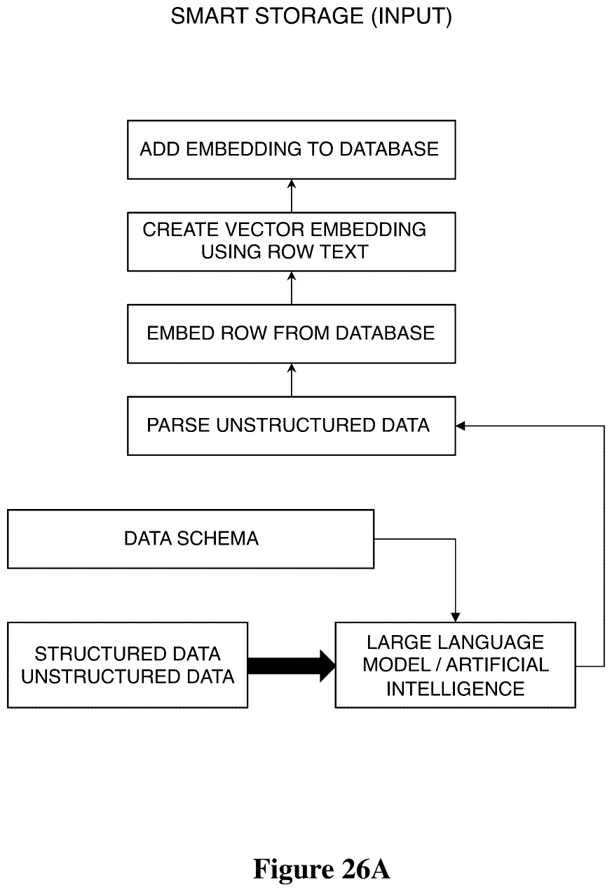

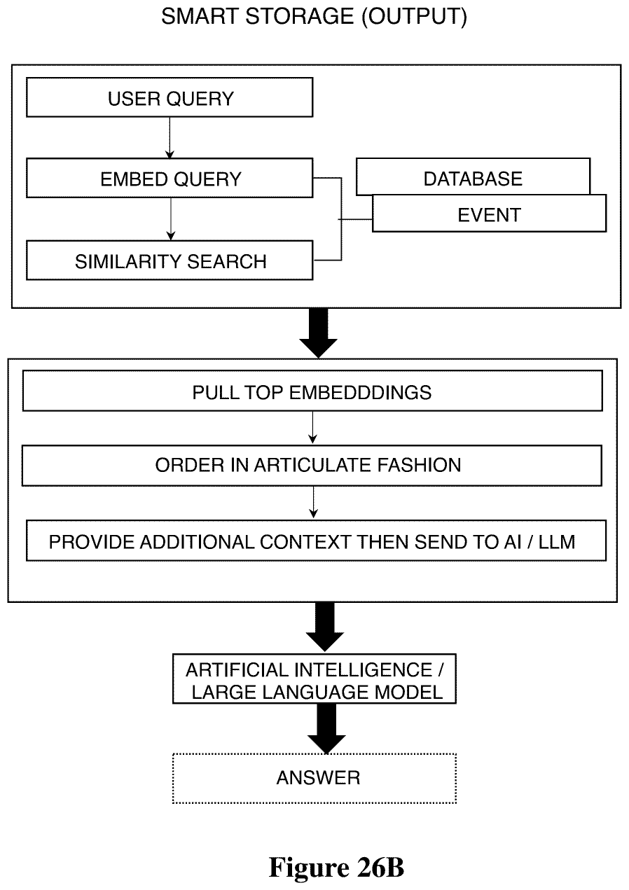

FIG. 26A depicts the SmartStorage System input model. Semi structured and structured data goes into the artificial intelligence and large language model. The database schema also goes into the artificial intelligence and large learning model and parses the unstructured data according to the database schema, and puts it into the database, or smart storage. The data, which can be inputted text data or variation of files, is a row of the database. The row is then embedded, and every piece of text data in the row is then created into a vector embedding. The embedding is then added to the database.

FIG. 26B depicts the SmartStorage System output model. A query, or question is input by the user. By way of example, the question can ask the system to generate a long or short summary of the film, or if they can provide an alternative ending to a film. The system then embeds the question and runs a similarity search between the embeddings of the question and the event in the database, pulling from various web crawls, APIs, data sets, and internet sources as well. A user can also provide additional context. The system pulls the top embedding, then reorders them in a manner that best articulates a response to the query. The results are sent to the language model and then the model generates a response for the user. While the example provided centers on screenwriting, it should be noted that input files can comprise of a myriad of document types, such as legal documents, contracts, academic papers, professional documents, interpersonal documents, and so on. The platform's Al organizes and categorizes a user's data and documents, making it easily accessible and searchable. The present system can assist creative and legal industries manage their projects and data by way of leveraging advanced AI and Large Language Models and the suite of tools that automate and enhance creative databasing, project tracking, and film/TV/manuscript coverage and using institutional memory and the Smart Storage database, thus facilitating seamless collaboration across teams. For example, one input can be a court case and the output generated can be a summary of the court case with the fact patterns.

While various embodiments of the disclosed technology have been described above, it should be understood that they have been presented by way of example only and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to implement the desired features of the technology disclosed herein. Also, a multitude of different constituent module names other than those depicted herein may be applied to the various partitions. Additionally, concerning flow diagrams, operational descriptions, and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects, and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open-ended as opposed to limiting. As examples of the preceding, the term “including” should be read as meaning “including, without limitation” or the like; the term “example” is used to provide exemplary instances of the item in the discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for streamlining content production, said system comprising:
a database stored in local and cloud memory and comprising a graphics processing unit;
a first processing device comprising a central processing unit and coupled to a memory and a storage device, wherein said storage device is cross-referenced to a cloud database and computer-readable programming software to execute code, wherein, when executed, said code causes said system to:
receive data;
analyze said data via artificial intelligence;
extract a portion of text from said data;
store said portion of text;
process said portion of text via a large language model chat;
identify in said portion of text, via said artificial intelligence, comprehensive story summaries;
generate, via said artificial intelligence, data relating to production of a creative project based on said comprehensive story summaries.

2. The system of claim 1, wherein said data relating to production of a creative project comprises prop lists, budgets, sociological trend metrics, and relevant marketing data.

3. The system of claim 1, wherein said artificial intelligence is a neural network trained via independent data.

4. The system of claim 1, wherein said large language model chat processes said portion of text to create search queries.

5. The system of claim 1, wherein a user interacts with said system via said large language model chat.

6. The system of claim 1, wherein said data is a text script.

7. The system of claim 1, wherein said data comprises description of a creative project.

8. A method for streamlining content production, said method comprising:
receiving data comprising at least a portion of text via a first processing device comprising a central processing unit and coupled to a memory and a storage device, wherein said storage device is cross-referenced to a cloud database and computer-readable programming software to execute code;
analyzing said data via artificial intelligence;
extracting said portion of text from said data via said artificial intelligence;
storing said portion of text in a database stored in local and cloud memory and comprising a graphics processing unit;
process said portion of text via a large language model chat;
identifying comprehensive story summaries in said portion of text via said artificial intelligence;
generating, via said artificial intelligence, data relating to production of a creative project based on said comprehensive story summaries.

9. The method of claim 8, wherein said data relating to production of a creative project comprises prop lists, budgets, sociological trend metrics, and relevant marketing data.

10. The method of claim 8, wherein said artificial intelligence is a neural network trained via independent data.

11. The method of claim 8, wherein said large language model chat processes said portion of text to create search queries.

12. The method of claim 8, wherein user interaction is enabled via said large language model chat.

13. The method of claim 8, wherein said data is a text script.

14. The method of claim 8, wherein said data comprises description of a creative project.

15. A system for streamlining content production using artificial intelligence, said system comprising:
a database stored in local and cloud memory and comprising a graphics processing unit;
a first processing device comprising a central processing unit and coupled to a memory and a storage device, wherein said storage device is cross-referenced to a cloud database and computer-readable programming software to execute code, wherein, when executed, said code causes said system to:
receive data comprising at least a portion of text;
analyze said data via artificial intelligence;
extract said portion of text from said data;
store said portion of text;
process said portion of text via a large language model chat to create search queries and configured to enable user interaction;
identify in said portion of text, via said artificial intelligence, comprehensive story summaries;
generate, via said artificial intelligence, data relating to production of a creative project based on said comprehensive story summaries.

16. The system of claim 15, wherein said artificial intelligence is a neural network.

17. The system of claim 16, wherein said neural network is trained via independent data.

18. The system of claim 15, wherein said data is a text script.

19. The system of claim 15, wherein said data relating to production of a creative project comprises prop lists, budgets, sociological trend metrics, and relevant marketing data.

20. The system of claim 15, wherein said data comprises description of a creative project.
